(19) United States
(12) Patent Application Publication
(10) Pub. No.: US 2003/0167951 A1
(43) Pub. Date: Sep. 11, 2003

(54) Method and devices for pressing a blanket against a cylinder

(76) Inventors: Norbert Edmund Schroder, Rieneck (DE); Andreas Ewald Heinrich Bernhard, Sulzfeld (DE); Karl Robert Schafer, Rimpar (DE)

Correspondence Address: Douglas R Hanscom, Jones Tullar & Cooper, Eads Station, P O Box 2266, Arlington, VA, 22202, US

(21) Appl. No.: 10/275,945

(22) PCT Filed: May 16, 2001
(86) PCT No.: PCT/DE01/01840

(30) Foreign Application Priority Data
May 17, 2000 (DE) 100-243-330.4

(51) Int. Cl. B41F 30/04; B41F 27/00

(52) U.S. Cl. 101/477; 101/375

(57) ABSTRACT

During mounting and dismounting of blankets (2) on cylinders (1), rollers (3) are pressed against the cylinder in order to ensure uniform winding and unwinding. It is necessary to apply a uniform positioning pressure for a low control and driving expenditure. According to the invention, such a device for pressing blankets against cylinders is obtained by applying simultaneously several movable rollers (3, 29), independently from each other, by means of a single actuator (4). According to a particular embodiment of the invention, first and second rollers can be actuated for respectively mounting and dismounting the blanket. The assembly can be protected against contamination by moving a protection (47) by means of the same actuator. A stop is used for the correct positioning of the plate at the forward end.

The invention relates to a method and devices for pressing a blanket against a cylinder, as defined in the preamble to claims 1 and 2 or 10.

EP 07 12 725 B1 has disclosed a device for pressing against printing plates with the aid of a number of rollers disposed along the cylinder circumference. In order to protect it from getting dirty, the device is disposed in a box-shaped dirt guard that can be moved out of the deployment region of the rollers. Additional opening flaps disposed on the dirt guard can be actuated by means of separate working cylinders.

EP 04 33 798 B1 has a pivotable guard for a changing device of a printing plate, which protects the entire apparatus oriented toward the access side from getting dirty. The pressing roller is embodied of one piece and working cylinders situated at both ends place it against the cylinder by means of a lever.

EP 07 10 556 B1 has disclosed a device for guiding the trailing end of the plate into the channel during plate installation. In this connection, after the leading end of the plate has been clamped in place and most of the plate has been mounted in place, a feeder carriage is moved against the cylinder and guides the trailing end of the plate into the channel by means of an insertion slider disposed on the carriage.

The object of the invention is to produce a method and devices for pressing against a blanket.

The object is attained according to the invention by means of the features of claims 1 and 2 or 10.

The advantages that can be attained with the invention are comprised particularly in that a guard is provided, which is for preventing the possibility of the rollers getting dirty when they are in the retracted position, wherein the rollers and the guard are actuated with the same adjusting mechanism. The movements can therefore occur synchronously and without incurring additional control and drive costs. It is particularly advantageous to couple the movable guards to the roller supports that are moved by the adjusting mechanism.

For an exact insertion of a leading end of a blanket, at least one stop is advantageously provided, which is stationary in relation to the machine stand. It is advantageous that when installing the blanket, the formation of the stop imparts an initial stress on the leading end, which permits the blanket to engage in detent fashion in the provided clamping or tensioning device in a manner that is reproducible because it is guided.

Exemplary embodiments of the invention are shown in the drawings and will be described in detail below.

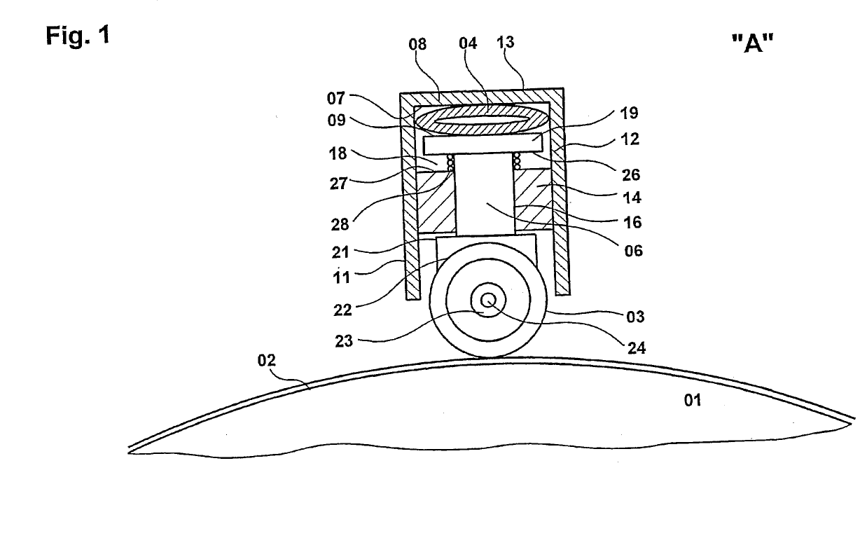

FIG. 1 shows a section through a first exemplary embodiment of the device for pressing against the blanket in the deployed position A;

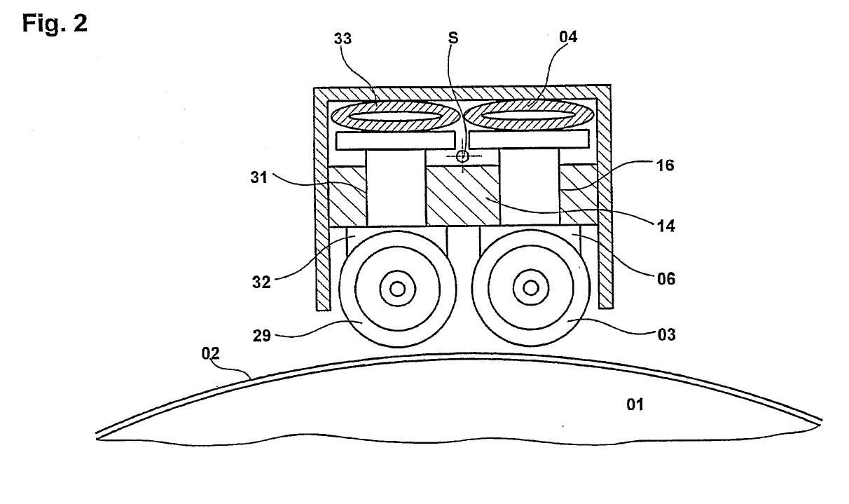

FIG. 2 shows a section through a second exemplary embodiment, using first and second rollers for installation and removal of the blanket;

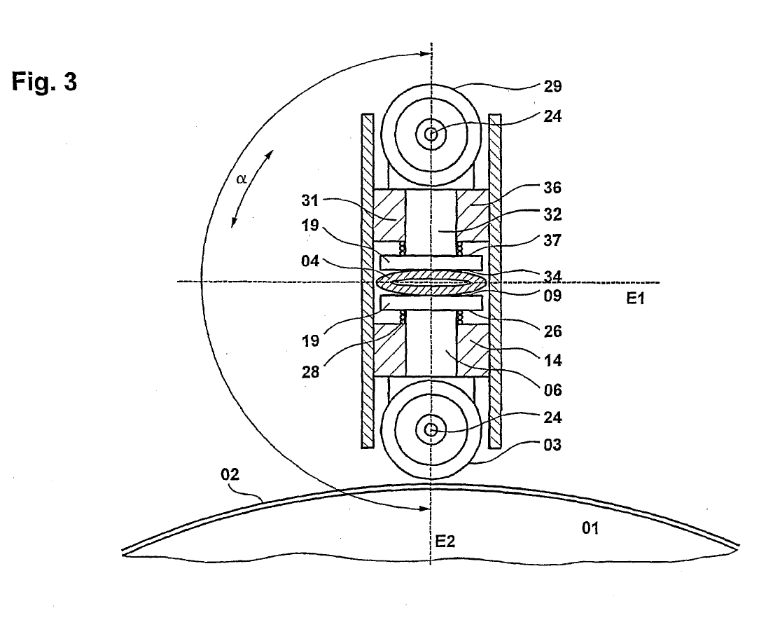

FIG. 3 shows a section through a third exemplary embodiment, using first and second rollers for installation and removal of the blanket;

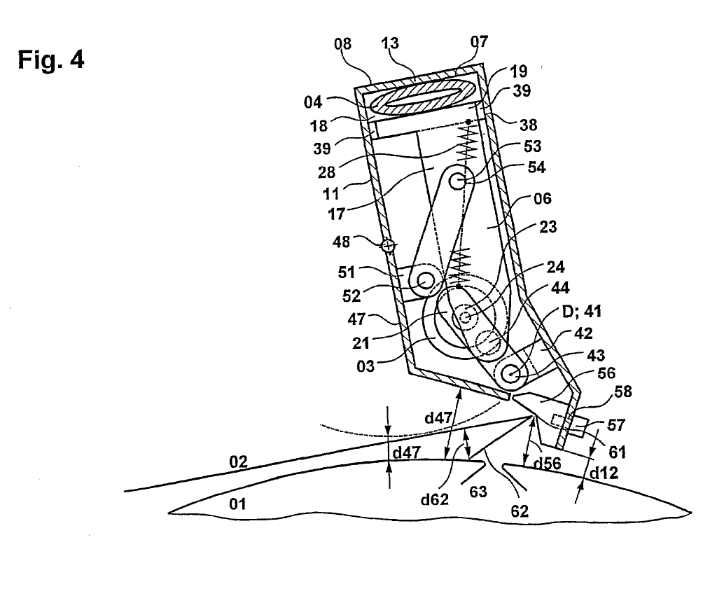

FIG. 4 shows a section through a fourth exemplary embodiment, with an increased stroke of the roller movement, pivoting guards for covering the rollers, and a stop for the secure insertion of the leading plate end;

A cylinder 01, for example a forme cylinder or transfer cylinder 01 of a rotary printing press, has a blanket 02, for example a printing plate 02 or a rubber blanket 02, disposed on it during operation.

The device is advantageously disposed so that it is stationary in relation to the cylinder 01, but only cooperates with the cylinder 01 when actuated. In order to install the blanket 02 onto the cylinder 01 or in order to remove the blanket, however, a device for pressing against the blanket 02 can also be pivoted against the cylinder 01 by means of a device that is not described in detail here. This can, for example, be achieved by means of pivotable lever arms, through linear motion against a threaded spindle, or with other linear drive mechanisms.

When the device for pressing against a blanket 02 is in the operational state, i.e. when changing the blanket 02, the device extends with its longitudinal direction approximately parallel to the rotation axis of the cylinder 01. During installation or removal of the blanket 02, a number of rollers 03, which are associated with the pressing device, are pressed against the rotating cylinder 01 by means of an adjusting mechanism 04.

The pressing device essentially has a number of rollers 03 spaced apart from one another in the longitudinal direction of the cylinder 01, roller supports 06 that support the rollers 03, the adjusting mechanism 04, a support surface 07, and possibly a frame 08. For example, the frame 08 can be disposed in a stationary or mobile fashion on a side stand that is not shown. For example, the adjusting mechanism 04 is embodied as a reversibly deformable hollow body 04, e.g. a hose 04, which can be acted on with pressure fluid. The frame 08 serves to contain the roller supports 06 and the hollow body 04 and can include the support surface 07. When acted on by pressure fluid, the hollow body 04 is supported against the support surface 07 and places the roller 03 against the cylinder 01 by means of a surface 09 of the roller support 06 that cooperates with the hollow body 04.

In a first exemplary embodiment, the frame 08 is disposed approximately parallel to the rotation axis of the cylinder 01 in the longitudinal direction and represents an approximately U-shaped crossbar 08 that has a base 13 and legs 11; 12 on opposite sides. Between the legs 11; 12, oriented away from the base 13, there is a strip 14. A number of guides 16 extend through the strip 14, spaced apart from one another in the longitudinal direction. For example, the guide 16 in the strip 14 is embodied as a bore or as a bore containing a sleeve or bearing bush and allows a strut 17 associated with the roller support 06 to move in a longitudinally guided fashion.

The strip 14, together with the two legs 11; 12 and the base 13, forms a hollow chamber 18 extending in the longitudinal direction. On its side oriented toward the hollow chamber 18, the base 13 has the support surface 07 that cooperates with the hollow body 04. The legs 11; 12 can also be embodied as struts or be omitted entirely.

The hollow body 04 is disposed in the longitudinal direction in the hollow chamber 18 between the two legs 11; 12, the base 13 with the support surface 07, and the surfaces 09 of the roller supports 06 that cooperate with the hollow body 04.

The roller support 06, which is embodied with two arms, essentially has a head 19—which is embodied e.g. as a plate 19, is disposed in the hollow chamber 18 of the frame 08, and cooperates with the hollow body 04—and has the two struts 17 that each protrude through a respective guide 16 of the strip 14 and are each provided with a foot 21, which supports the roller 03. The strut 17, for example a cylindrical rod 17, is disposed so that it can slide in relation to its longitudinal direction in the guide 16 of the strip 14 and connects the components at its respective ends, namely connecting the plate 19 disposed in the hollow chamber 18 to the foot 21, which is disposed outside the hollow chamber 18, supports the roller 03, and is embodied, for example, in the form of a leg 21. The cross section of the rod 17 approximately corresponds to the cross section of the guide 16 and/or the inner diameter of a bearing bush or sleeve provided for better axial guidance.

On at least one of its side surfaces 22, the leg 21 has a radial bearing 23, for example a bearing bush 23 for containing an axle 24 associated with the roller 03. The roller 03 is disposed between the two legs 21 so that its longitudinal axis extends approximately parallel to the rotation axis of the cylinder 01 during a plate change.

At each of its ends, the roller 03 has an end of the axle 24, which either passes all the way through the roller 03 or is discontinuous, and these axle ends each cooperate with an associated bearing bush 23 in the leg 21. The roller 03 can be a rubber roller, a plastic roller, or a different roller 03 whose running surface is provided with a soft covering that does not damage the blanket 02.

On its side oriented toward the hollow body 04, the plate 19 has the surface 09 that cooperates with the hollow body 04. The surface 26 of the plate 19 opposite from the surface 09 cooperates as a stop 26 with the surface 27 of the strip 14 oriented toward the hollow chamber 18. It is advantageous to dispose at least one flexible element 28, e.g. a spring 28, between the surface 27 of the strip 14 and the surface 26. This is achieved, for example, by means of the spring 28 either encompassing the rod 17 or being inserted into recesses in the plate 19 and the strip 14.

The roller support 06 can also be embodied as one-armed, wherein each rod 17 is associated with an individual plate 19 disposed in the hollow chamber 18. In this embodiment, two roller supports 06 respectively disposed in the guide 16 cooperate to support the roller 03. The plate 19, rod 17, and legs 21 can also be embodied of one piece with one another, wherein the roller support 06, at the end protruding into the hollow chamber 18, i.e. the head 19, advantageously has an enlarged cross section or at least a stop 26, and at least on an end protruding from the strip 14, i.e. the foot 21, has a bearing bush 23.

The head 19 of the roller support 06 can also be embodied as a plate 19, which extends over several rollers 03 and on which the rods 17 and feet 21 for several rollers 03 are disposed.

In each embodiment, the roller supports 06 and rollers 03 are disposed on the strip 14 so that the rollers 03 that are spaced apart from each other in the longitudinal direction are each supported so that they can rotate around an axis extending approximately parallel to the rotation axis of the cylinder 01 when the device for pressing against the cylinder 01 is pivoted.

The device for pressing against a blanket 02 with a number of first rollers 03 according to the first exemplary embodiment functions as follows: in order to change the printing plate 02, the pressing device is pivoted against the cylinder 01 so that the rotational axis of the cylinder 01 and the axle 24 of the roller 03 extend approximately parallel to each other. In this position, the hollow body 04 is acted on by pressure fluid. When the hollow body 04 is acted on by pressure fluid and the resulting reversible shape change to the hollow body 04 occurs, the hollow body 04 is supported against the support surface 07 and presses all of the roller supports 06 resting against the surfaces 09 simultaneously, counter to the force of the springs 28, outward with the same pressure against the blanket 02. The rollers 03 and roller supports 06 are disposed in the deployed position A. A slight deviation in the position of the device or an inclination of the cylinder 01 is compensated for by the pressure uniformly prevailing over the entire length of the hollow body 04 by virtue of the fact that rollers 03, which are spaced further apart from the cylinder 01, are displaced further out from the hollow chamber 18. All of the roller supports 06 are pushed out from the hollow chamber 18 until they come into contact with the same force against the blanket 02. However, the latter only occurs in the tolerance range established by the length of the rod 17 protruding into the hollow chamber 18.

In another embodiment of the invention, in addition to the first rollers 03, which are spaced apart from one another and which are placed against the cylinder 01 in order to install new blankets 02 onto it, the device can also have a number of second rollers 29, which are placed against the blanket 02 in order to remove it.

In a second embodiment (FIG. 2), with a number of first rollers 03 and a number of second rollers 29, the widened U-shaped frame 08 contains a widened guide 14, which has a row of second guides 31 in the longitudinal direction of the device, parallel to the row of first guides 16. The second roller supports 32, with the second rollers 29 parallel to the first rollers 03, are supported so that they can slide in these second guides 31. A second adjusting mechanism 33 e.g. a second hollow body 33, is disposed in the hollow chamber 18 between the support surface 07 and the surfaces 34 of the second roller supports 32 cooperating with the hollow body 04. The first roller supports 06 and the second roller supports 32 can also be actuated by means of a single hollow body 04 that is correspondingly embodied and positioned.

According to the second exemplary embodiment, in order to change the blanket 02, first the second rollers 29 are placed against the cylinder 01. This can be executed by acting on the hollow body 33 with pressure fluid and additionally by pivoting the frame 08 if need be around an axis ending in the longitudinal direction, for example a shared pivot axis S so that only the second rollers 29 are disposed in the deployed position A and cooperate with the blanket 02. After the old blanket 02 is removed the new blanket 02 is secured in place, the hollow body 04 is acted on with pressure fluid and the frame 08 is pivoted if need be in the opposite direction so that only the first rollers 03 cooperate with the new blanket 02 and are disposed in the deployed position A.

If the first roller supports 06 and second roller supports 32 are actuated jointly by means of a hollow body 04, then the selection of the rollers 03 or 29 to be activated is executed exclusively by pivoting the frame 08 around the axis extending in the longitudinal direction, for example the pivot axis S. The uniform adjusting force against the cylinder 01 for a number of rollers 03 or 29 associated with one hollow body 04 is exerted by acting on the hollow body 04 with pressure fluid.

In a third embodiment (FIG. 3) for the arrangement of a number of first rollers 03 and second rollers 29, the first rollers 03 and second rollers 29 are situated approximately diametrically opposite from each other on the frame 08. In contrast to the device described in conjunction with FIG. 1, in this instance, the base 13 that borders the hollow chamber 18 is eliminated. Instead of the base 13, a second strip 36 with second roller supports 32 and the second rollers 29 is provided, which is mirror symmetrical to a plane, the plane of symmetry E1, and to the hollow body 04. The second roller supports 32 have surfaces 34 that cooperate with the hollow body 04 and have a surface 37 that cooperates as a stop 37 with the second strip 36. The legs 11; 12 can be elongated, thus assuring the device of being covered at the sides. The pressing device can be pivoted by means of a device not shown in relation to the longitudinally extending pivot axis S, which lies in the plane of symmetry E1 and extends parallel to the axles 24 of the first rollers 03 and second rollers 29. With a diametrical disposition of the rollers 03; 29, the shared pivot axis S advantageously coincides with the intersecting line of the plane of symmetry E1 and a plane E2 extending through the axles 24 of the first rollers 03 and second rollers 29.

In order to change the blanket 02 by means of the third exemplary embodiment, first the second rollers 29 are placed against the cylinder 01. This is achieved by pivoting the frame 08 around the longitudinally extending pivot axis S and then acting on the hollow body 04 with pressure fluid so that the second rollers 29 cooperate with the blanket 02 and are disposed in the deployed position A. In this connection, the two roller supports 06; 32 are pushed apart from each other, for example until the stop 26 of the freely moving roller support 06 cooperates with the first strip 14. In a manner that corresponds to the support surface 07 from the first exemplary embodiment (FIG. 1), the surface 09 of the first roller support 06 cooperates with the hollow body 04 as a support surface 09. When the hollow body 04 relaxes, the roller support 32 is reset by the spring 28. After the old blanket 02 is removed and the new blanket 02 is secured in place, the frame 08 is pivoted, for example by 180°, so that after the hollow body 04 is acted on with pressure fluid, the first rollers 03 cooperate with the new blanket 02 and are disposed in the deployed position A. When the hollow body 04 is acted on, the stop 37 cooperates with the second guide 36 and the surface 34 cooperates as a support surface 34 with the hollow body 04.

The first roller supports 06 and the second roller supports 32 can also be disposed at other angles α enclosed between the first rollers 03, the hollow body 04, and the second rollers 29. The exemplary embodiments 2 and 3 show the two extremes for a number of first rollers 03 and second rollers 29 disposed next to one another in parallel (α=0°) and diametrically opposite one another in relation to the hollow body 04 (α=180°).

The fourth exemplary embodiment (FIG. 4) shows another device for pressing against the blanket 02, where the stroke produced by the deformation of the hollow body 04 is multiplied into an increased movement of the rollers 03.

The hollow body 04 and several rollers 03 are disposed extending longitudinally approximately parallel to the rotation axis of the cylinder 01 in the frame 08. The frame 08 is an approximately U-shaped crossbar 08 with a base 13 and legs 11; 12 disposed opposite each other. In an advantageous embodiment, the leg length l12 of the leg 12 is embodied as longer than the length l11 of the leg 11. The leg 12 of the U-shaped crossbar 08 can open outward at its outer end.

The hollow body 04 is disposed inside the U-shaped crossbar 08, extending in its longitudinal direction, between the support surface 07 associated with the base 13, the legs 11 and 12, and the surfaces 09 of the roller supports 06 cooperating with the hollow body 04.

The roller support 06 essentially has the head 19, which cooperates with the hollow body 04, and at least one strut 17 on which the foot 21 is disposed that respectively supports the roller 03. The strut 17 is at least disposed with its head 19 positioned between the legs 11; 12 in the frame 08. It is advantageous to provide one roller support 06 per roller 03, the roller support 06 having two struts 17, each with a foot 21 for supporting the roller 03.

On its side oriented toward the hollow body 04, the head 19 of the roller support 06 has the surface 09 and approximately perpendicular to this, has two surfaces 38, with which the roller support 06 is supported against the leg 11 and/or 12 of the frame 08. For example, the head 19 is embodied as a plate 19. The surface 38 can also be the surfaces oriented toward the leg 11, 12 of several sliding feet 39 or supporting feet 39 that are disposed next to and spaced apart from each other and are disposed on the plate 19, on the sides oriented toward the legs 11; 12. The strut 17 connects the plate 19 disposed at its first end to the foot 21 of the roller support 06 disposed at its second end, which supports the roller 03. The plate 19 and the two struts 17 can also be embodied as being of one piece with one another.

In contrast to the foot 21, which is rigidly connected to the strut 17 in the first exemplary embodiment, in the current embodiment, the foot 21 of the roller support 06 is embodied as a rocker or as a one-armed lever 21, which is actuated by means of the strut 17 that functions as a tappet 17. The lever 21 is supported so that it can rotate around a fulcrum 41 situated at a first end of the lever 21.

The fulcrum 41 of the lever 21 is disposed on a rotation axis D, which extends approximately perpendicular to the longitudinal direction of the strut 17 and approximately parallel to the axle 24 of the rollers 03 and is stationary in relation to the frame 08. For example, this fulcrum is embodied as a linkage comprised of a fork head 42 fastened to the leg 12 and a bolt 43 that passes through the fork head 42 and the lever 21.

Spaced apart from the fulcrum 41, the strut 17 engages the lever 21. The lever 21 and strut 17 are connected to each other so that they can rotate around an axis approximately parallel to the axle 23 of the rollers 03. This occurs, for example, by means of a bolt 44, which is disposed in bores in the lever 21 and the strut 17.

The bearing bush 23 or a similar mechanism suitable for supporting the roller 03 is disposed at the second end of the lever 21 opposite from the fulcrum 41. In an advantageous embodiment, two levers 21 to be respectively associated with a single roller support 06 support one roller 03. The roller 03 is disposed between the two levers 21 so that its axle 24 extends approximately parallel to the axis of the cylinder 01 when the levers 21 are actuated by means of the respective strut 17 of the roller support 06.

The rollers 03 can also be placed against the cylinder 01 by means of two-armed levers and differently embodied or differently positioned linkage elements, wherein when acted on with pressure fluid, the hollow body 04 actuates a drive element through reversible deformation and the stroke of the resulting linear movement on the drive element is translated, possibly by means of a corresponding coupling, into a movement of the rollers 03. It is advantageous to have a transmission, which multiplies the stroke of the linear movement during deformation of the hollow body 04 into a greater movement of the rollers 03.

The resetting of the rollers 03 or the roller support 06 is advantageously produced by means of spring force. For example, a spring 46 acting on the lever 21 can be fastened to the frame 08 or the strut 17. It is also possible to place a compression spring between the head 19 and a stop that is not shown.

In a preferred modification of the invention, when the device is not actuated, the U-shaped profile of the frame 08 is closed by means of one or more guards 47 disposed next to one another in the longitudinal direction of the frame 08. The guard 47 is fastened to the shorter leg 11 and can pivot in relation to an axis extending in the longitudinal direction of the frame 08, for example by means of a hinge 48, a strap hinge, or articulating joints. The guard 47 is embodied so that it completes the frame 08 in the circumference direction on the shorter leg 11 and at the open end of the U-shaped cross section. When the leg lengths l11 and l12 are the same, the guard 47 only closes off the open end of the U-shaped frame 08.

On the side oriented toward the inside of the frame 08, the guard 47 has for example a coupler 49, which is disposed on the guard 47 and on the roller support 06, e.g. on the strut 17, so that it can pivot around an axis approximately parallel to the longitudinal direction of the frame 08. The pivoting connection of the coupler 49 to the guard 47 is embodied, for example, as a hinge joint with a link plate 51 and a bolt 52. The coupler 49 is fastened to the strut 17 for example by means of a bolt 53, which engages in a form-fitting manner in a bore 54 in the strut 17. The guard 47 and the coupler 49 are disposed on the frame 08 or on the strut 17 so that when the roller support 06 is in the rest position, i.e. when the strut 17 is not slid toward the opening by the hollow body 04, the guard 47 and the U-shaped frame 08 together encompass the rollers 03 and the adjusting mechanism, i.e. they completely enclose the roller support 06 and the hollow body 04.

The guard 47 can also be coupled to the roller support 06 by other means so that it is opened or closed simultaneously during deployment or retraction of the rollers 03 without incurring additional drive or control costs. It is also possible to provide a parallel arrangement of a number of hollow bodies 04 next to each other in the longitudinal direction of the cylinder 01 or one after the other in the circumference direction of the cylinder 01, for example in order to actuate first or second rollers 03; 29 in a manner that corresponds to the apparatus according to the exemplary embodiment 2. The first and second rollers 03; 29 can also the disposed next to one another, for example in alternating fashion, in the longitudinal direction of the cylinder 01, wherein the first rollers 03 cooperate by means of a first roller support 06 with a first hollow body 04 and the second rollers 29 cooperate by means of a second roller support 32 with a second hollow body 33.

The pivoting frame 08 described in exemplary embodiment 4 is preferably disposed so that it is stationary in relation to the cylinder 01, parallel to its rotational axis. The frame 08 and the guard 47 can be embodied so that when the guard 47 is in the closed position, there is an extremely short distance d47 of preferably between 20 and 25 mm in the engagement region between the guard 47 and the cylinder 01. When the device is disposed between two cylinders 01 that touch, for example a plate cylinder and a rubber blanket cylinder of a printing press, the form of the frame 08 and the guard 47 can be embodied so that the device also functions simultaneously as a guard that prevents things from being pulled in between the two rotating cylinders 01. To this end, a maximal distance of d12=6 mm and/or d47=6 mm should be maintained in the respective outer engagement region between the cylinder 01 and the frame 08 and/or guard 47, for example between the free end of the leg 12 and the cylinder 01 or, when the flap 47 is open, between the free end of the flap 47 and the cylinder 01. It is advantageous to maintain an obtuse angle toward the operational side in the above-mentioned engagement regions between the cylinder 01 and the pressing device. This can occur by correspondingly embodying the frame 08 and guard 47 or by also providing sheet metal strips, for example.

In a preferred embodiment form, a stop 56 is disposed at the end of the leg 12 oriented toward the cylinder 01 in order to facilitate an even, guided placement of the printing plate 02 to be installed. The stop 56 can be of one piece. Preferably, several stops 56 are provided on the frame 08, which are disposed next to and spaced apart from one another in the longitudinal direction of the frame 08. They are attached to the frame 08 by means of positive and/or frictional engagement, for example by means of screws 57 at a curved end of the leg 12. However, they can also be part of the leg 12. If the stops 56 are attached by means of screws 57, it is advantageous for the stops 56 to be adjustable in relation to the position of the cylinder 01, for example by embodying the bores 58 as oblong holes.

On the side 59, which is oriented toward the cylinder 01 and cooperates with a leading end 62 of the printing plate 02, the form and position of the stop 56 are embodied in such a way that a distance d56 between the stop 56 and the cylinder 01 tapers in the circumference direction of the cylinder 01. For example, the side 59 can be embodied of two pieces and so that it is angled in relation to a line 61 extending parallel to the rotation axis of the cylinder 01, wherein the first section of the side 59 disposed in the insertion region of the leading end 62 of the printing plate 02 is inclined less sharply in relation to the cylinder 01 and the subsequent second section is inclined more sharply in relation to the cylinder 01. The distance d56 between the cylinder 01 and the stop 56 should, on the line 61 of the bend 61 or at least in the course of the second section of the side 59, be less than the width d62 of the bent leading end 62 of the printing plate 02.

According to the fourth exemplary embodiment, the installation of the blanket 02 on the cylinder 01 by means of the device takes place as follows: The forme cylinder 01 is rotated into a position in which channel opening 63 that receives the leading end 62 of the printing plate 02 comes to rest approximately opposite from the stops 56. With its bent leading end 62, the printing plate 02 is inserted between the forme cylinder 01 and the pressing device and is positioned against the stops 56. When the printing plate 02 is inserted, the bent end 62 of the printing plate 02 is prestressed by the form of the stops 56 and automatically snaps into the channel opening 63. After the leading end 62 is clamped in the channel, the hollow body 04 is acted on with pressure fluid. This opens the guard 47 by means of the strut 17 and simultaneously places several individually movable rollers 03 against the cylinder 01. If space conditions require, after the leading end 62 is clamped in position and before the opening of the guard 47 and the deployment of the rollers 03, the cylinder 01 can first be positioned, either in the production direction or in the opposite direction. The positioning of the cylinder 01 occurs in an advantageous fashion so that the rollers 03 are placed against the blanket 02 directly on or close to the channel opening 63. After the rollers 03 are deployed, the cylinder 01 is rotated in the production direction until the rollers 03 come to rest against the channel 63 again and guide a trailing plate end into the channel opening 63.

The opening and closing of the locking mechanisms for the leading end 62 and the trailing end in the channel opening 63 are preferably actuated automatically and coordinated with the sequence of the above-described procedures of the plate replacement. The removal of the blanket 02 from the cylinder 01 essentially occurs in the reverse sequence.

All of the embodiments share the fact that a single adjusting mechanism 04 or 33 is used to respectively place a number of first rollers 03 and/or second rollers 29, which are actuated simultaneously and directly, against the cylinder 01 in that the adjusting mechanism 04 cooperates with the surface 09; 34 of a roller support 06; 32. In all of the alternative embodiments, in the deployed position A, the same force is exerted directly on all of the rollers 03; 29 over the length of the device.

### REFERENCE NUMERAL LIST

01 cylinder, forme cylinder, transfer cylinder

02 blanket, printing plate, rubber blanket

03 first roller

04 adjusting mechanism, hollow body, hose

05 -

06 first roller support

07 support surface (13)

08 frame, crossbar

09 surface, support surface (06)

10 -

11 leg (08)

12 leg (08)

13 base (13)

14 first strip

15 -

16 guide (14)

17 strut, rod, tappet (06)

18 hollow chamber

19 head, plate (06)

20 -

21 foot, lever, leg (06)

22 side surface (21)

23 radial bearing, bearing bush (21)

24 axle (03; 29)

25 -

26 surface, stop (06)

27 surface (14)

28 flexible element, spring

29 second roller

30 -

31 second guide

32 second roller support

33 second adjusting mechanism, second hollow body

34 surface, support surface (32)

35 -

36 second strip

37 surface, stop (32)

38 surface (19)

39 sliding foot, supporting foot (19)

40 -

41 fulcrum (21)

42 fork head

43 bolt (42)

44 bolt (17)

45 -

46 spring

47 guard

48 hinge (47)

49 coupler (47)

50 -

51 link plate (47)

52 bolt (49)

53 bolt (17)

54 bore (17)

55 -

56 stop

57 screw (56)

58 bore (12)

59 side (56)

60 -

61 line (56)

62 leading end (02)

63 channel opening (01)

A deployed position

D fulcrum, rotation axis

S pivot axis

E1 plane of symmetry, plane

E2 plane

d16 diameter (16)

d19 diameter (19)

d47 distance (47)

d56 distance (56)

d62 width (62)

l11 length (11)

l12 length (12)

α angle

1. A method for pressing a blanket (02) against a cylinder (01), with at least one roller (03), which is deployed and retracted by means of an adjusting mechanism (04), and wherein the roller (03) can be covered in the direction of the cylinder (01) by means of an actuatable guard (47), characterized in that the guard (47) and the roller (03) are actuated by the same adjusting mechanism (04).

2. A device for pressing a blanket (02) against a cylinder (01), with at least one roller (03), which is deployed and retracted by means of an adjusting mechanism (04), and wherein the roller (03) can be covered in the direction of the cylinder (01) by means of an actuatable guard (47), characterized in that the guard (47) and the roller (03) can be actuated by the same adjusting mechanism (04).

3. The device according to claim 2, characterized in that the guard (47) is disposed so that it can be pivoted around a stationary axis in relation to the cylinder (01).

4. The device according to claim 3, characterized in that the axis extends approximately parallel to the rotation axis of the cylinder (01).

5. The device according to claim 2, characterized in that the guard (47) can be actuated directly by the adjusting mechanism (04).

6. The device according to claim 2, characterized in that the guard (47) can be actuated by means of a transmission.

7. The device according to claim 2, characterized in that the guard (47) is coupled to at least one roller support (06) that supports one or more rollers (03).

8. The device according to claim 2, characterized in that the adjusting mechanism (04) is embodied as a reversibly deformable hollow body (04) that can be acted on with pressure fluid.

9. The device according to claim 7, characterized in that the guard (47) is connected by means of a coupler (49) that is disposed in a pivoting fashion on both the guard (47) and the roller support (06).

10. A device for pressing a blanket (02) against a cylinder (01), wherein the device has at least one stop (56), which is spaced apart from the cylinder (01) and cooperates with an acutely bent leading end (62) of a blanket (02) and which, on its side (59) oriented toward the cylinder (01), is inclined toward the cylinder (01) in the circumference direction of the cylinder (01) so that the internal width between the cylinder (01) and the stop (56) tapers in the circumference direction of the cylinder (01), characterized in that the stop (56) is disposed so that it is stationary in relation to the cylinder (01) and that the internal width between the cylinder (01) and the side (59) of the stop (56) oriented toward the cylinder (01), at least at the narrowest point, is smaller than the width (d62) of the bent leading end (62) of the blanket (02).

11. The device according to claim 10, characterized in that the distance between the cylinder (01) and the stop (56) in a region that receives the leading end (62) is greater than the width (d62) of the bent leading end (62) of the blanket (02).

12. The device according to claim 10, characterized in that several stops (56) are disposed in a row parallel to the channel opening (63) of the cylinder (01).

13. The device according to claims 2 or 10, characterized in that the cylinder (01) is a forme cylinder (01) of a printing press.
